(19) United States
(12) Patent Application Publication
(10) Pub. No.: US 2025/0333057 A1
(43) Pub. Date: Oct. 30, 2025

(54) VEHICLE CONTROLLER AND STORAGE MEDIUM COMPRISING VEHICLE CONTROL PROGRAM

(71) Applicants: J-QuAD DYNAMICS Inc., Tokyo (JP); DENSO CORPORATION, Kariya-city (JP)

(72) Inventors: Yuka SATRE, Tokyo (JP); Yoshihiro HIROHASHI, Kariya-city (JP); Ryoma NIIHARA, Kariya-city (JP); Kazuki IZUMI, Kariya-city (JP); Shiori MANEYAMA, Kariya-city (JP)

(21) Appl. No.: 19/073,183

(22) Filed: Mar. 7, 2025

(30) Foreign Application Priority Data
Apr. 26, 2024 (JP) 2024-072119

(51) Int. Cl. B60W 30/14; B60W 40/06; B60W 50/14

(52) U.S. Cl. CPC B60W 30/146; B60W 40/06; B60W 50/14; B60W 2555/20; B60W 2720/106

(57) ABSTRACT

A vehicle controller includes a water level estimating unit and an upper limit setting unit. The water level estimating unit is configured to estimate a water level on a road surface on which a vehicle is traveling based on audio data related to sound vibration measured at the vehicle. The upper limit setting unit is configured to set a maximum speed based on the water level estimated by the water level estimating unit, the maximum speed being an upper limit of a driving speed of the vehicle.

### CROSS REFERENCE TO RELATED APPLICATION

The present application claims the benefit of priority from Japanese Patent Application No. 2024-072119 filed on Apr. 26, 2024. The entire disclosure of the above application is incorporated herein by reference.

### TECHNICAL FIELD

The disclosure herein relates to vehicle control technology.

### BACKGROUND

There is a ground contact load controller that increases the ground contact load of a tire that is determined to be undergoing hydroplaning.

### SUMMARY

One disclosed aspect is a vehicle controller including a water level estimating unit and an upper limit setting unit. The water level estimating unit is configured to estimate a water level on a road surface on which a vehicle is traveling based on audio data related to sound vibrations measured at the vehicle. The upper limit setting unit is configured to set a maximum speed, which is an upper limit of a driving speed of the vehicle, based on the water level estimated by the water level estimating unit.

Another disclosed aspect is a computer readable storage medium including a vehicle control program that causes a processor to estimate a water level on a road surface on which a vehicle is traveling based on audio data related to sound vibrations measured at the vehicle, and to set a maximum speed that is an upper limit of a driving speed of the vehicle based on the estimated water level.

### BRIEF DESCRIPTION OF THE DRAWINGS

FIG. 1 a block diagram illustrating the overall configuration of an in-vehicle system including a vehicle control ECU of an embodiment of the present disclosure.

FIG. 2 is a diagram showing an example of an upper limit setting table that defines the correspondence relationship between an estimated water level and a maximum speed.

FIG. 3 is a diagram showing a speed limit control for a vehicle performed in an automated driving scene in which the vehicle is driven by automated driving control in detail.

FIG. 4 is a diagram showing a speed limit control performed in a manual driving scene in which the vehicle is driven by driver's manual operation in detail.

FIG. 5 is a flowchart illustrating the details of a SL setting process executed by the vehicle control ECU.

FIG. 6 is a flowchart illustrating the details of a speed control process executed by the vehicle control ECU.

FIG. 7 is a flowchart illustrating the details of a speed waring process executed by the vehicle control ECU.

### DESCRIPTION OF EMBODIMENTS

To begin with, examples of relevant techniques will be described.

There is a ground contact load controller that increases the ground contact load of a tire that is determined to be undergoing hydroplaning with a ground contact load increasing mechanism. The ground contact load controller can restore the grip of the tire that is undergoing hydroplaning with such operation.

The ground contact load controller described above deals with occurred hydroplaning, but does not control the vehicle to travel not to cause hydroplaning.

The present disclosure provides a vehicle controller and a vehicle control program that control a vehicle to travel without causing hydroplaning.

One disclosed aspect is a vehicle controller including a water level estimating unit and an upper limit setting unit. The water level estimating unit is configured to estimate a water level on a road surface on which a vehicle is traveling based on audio data related to sound vibrations measured at the vehicle. The upper limit setting unit is configured to set a maximum speed, which is an upper limit of a driving speed of the vehicle, based on the water level estimated by the water level estimating unit.

Another disclosed aspect is a vehicle control program that causes a processor to estimate a water level on a road surface on which a vehicle is traveling based on audio data related to sound vibrations measured at the vehicle and set a maximum speed that is an upper limit of a driving speed of the vehicle based on the estimated water level.

In these aspects, the water level on the road surface on which the vehicle is traveling is estimated based on the audio data, and the maximum speed can be set according to the estimated water level on the road surface. Controlling the driving speed according to the maximum speed allows the vehicle to travel without causing hydroplaning.

Combinations of claims that are not explicitly stated in claims by dependency are also included in a scope of the present disclosure unless there is a particular difficulty existing in the combination.

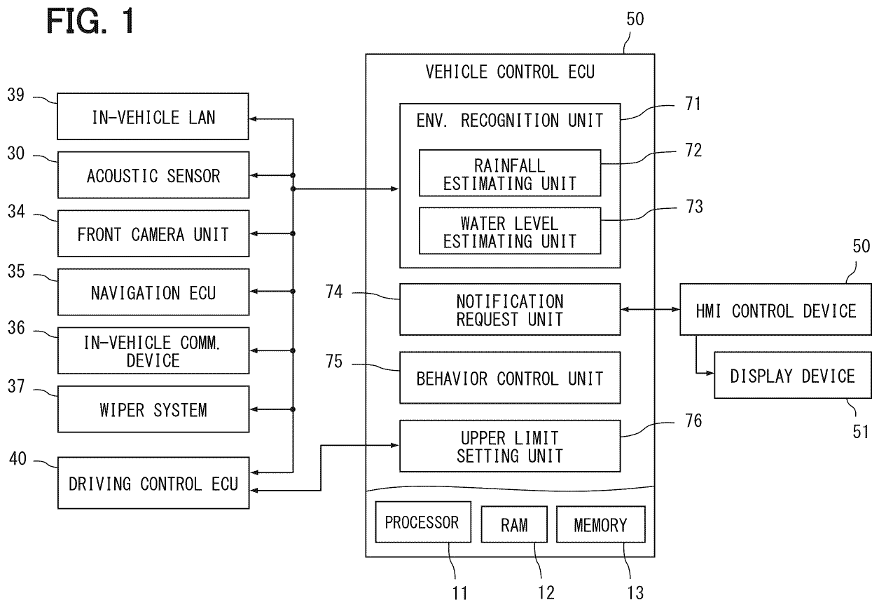

Function of a vehicle controller according to one embodiment of the present disclosure is implemented by a vehicle control Electronic Control Unit (ECU) 100 shown in FIG. 1. The vehicle control ECU 100 is mounted on a vehicle Ve (hereinafter also referred to as an own vehicle). The vehicle control ECU 100 is an Advanced Driver-Assistance Systems (ADAS)-ECU capable of implementing driving assistance control, an autonomous driving ECU capable of implementing autonomous driving control, or the like. Driving assistance control is driving control for driving automation level 2 or below, which requires the driver to visually monitor the area around the vehicle, and obliges the driver at least to monitor the area around the vehicle. Autonomous driving control is driving control for driving automation level 3 or above, which does not require the driver to monitor the area around the vehicle, and does not oblige the driver to monitor the area around the vehicle. The automated driving levels in this disclosure are based on standards established by the Society of Automotive Engineers. In addition, in the following description, driving assistance control and autonomous driving control will be collectively referred to as “automated driving control.”

(Configuration of In-vehicle System) The vehicle control ECU 100 is one of multiple in-vehicle ECUs included in the in-vehicle system installed in the vehicle Ve. The vehicle control ECU 100 is connected to a communication line of an in-vehicle Local Area Network (LAN) 39 for constructing the in-vehicle system. The in-vehicle LAN 39 may be constructed using a communication standard such as Controller Area Network (CAN, registered trademark) or Ethernet (registered trademark). Various vehicle information (for example, vehicle speed information) is output to the in-vehicle LAN 39. The communication line is connected to an acoustic sensor 30, a front camera unit 34, a navigation ECU 35, an in-vehicle communication device 36, a wiper system 37, a driving control ECU 40, an Human Machine Interface (HMI) control device 50, and the like. These nodes connected to the communication line can communicate with each other. Specific nodes among these notes may be electrically connected directly to each other to communicate with each other without through the communication line.

The acoustic sensor 30 is mainly composed of a microphone element that converts sounds into electrical signals. The microphone element functions as a condenser microphone that outputs, as electrical signals, a change in capacitance caused by a thin diaphragm vibrating due to sound pressure. The microphone element may be a Micro Electro Mechanical Systems (MEMS) microphone, an electret condenser microphone, or the like. The acoustic sensor 30 may be a piezoelectric microphone using a piezoelectric sensor instead of a condenser microphone. A piezoelectric sensor converts sounds into electrical signals using a piezoelectric element. The acoustic sensor 30 outputs audio data related to sound vibrations, which is generated by each microphone element, to the vehicle control ECU 100 as detection information.

The acoustic sensor 30 is disposed within the fender of the tire of the vehicle Ve to collect sound vibrations generated near the tire. As an example, the acoustic sensor 30 is attached to the back surface of the wheel well cover with the sound collecting surface facing the tire. The acoustic sensor 30 mainly measures road noise generated by the tire rolling on the road surface. The acoustic sensor 30 may be at least one acoustic sensor 30 provided near the left front tire or the right front tire of the vehicle Ve. For example, the acoustic sensor 30 is mounted on the vehicle Ve as one of the left front sensor or the right front sensor. The left front sensor is the acoustic sensor 30 that is installed on the wheel well cover of the left front tire and generates audio data near the left front tire. The right front sensor is the acoustic sensor 30 that is installed on the wheel well cover of the right front tire and generates audio data near the right front tire. Alternatively, both the left front sensor and the right front sensor may be mounted as the acoustic sensors 30 on the vehicle Ve. Furthermore, an acoustic sensor 30 other than the left front sensor and the right front sensor may be mounted on the vehicle Ve.

The front camera unit 34 is installed in a cabin of the vehicle Ve near the rearview mirror. The front camera unit 34 is a monocular or multi-lens camera, and is directed in a forward direction of the vehicle Ve. The front camera unit 34 continuously captures images of the area in front of the vehicle Ve, thereby generating imaging data that captures moving or stationary objects in front of the vehicle Ve. The front camera unit 34 outputs the generated imaging data or analysis information of the imaging data to the vehicle control ECU 100 as detection information. In addition to the acoustic sensor 30 and the front camera unit 34, the vehicle Ve may further be equipped with at least one of a rear camera, a side camera, a millimeter wave radar, a lidar, a sonar, and the like as an autonomous sensor to monitor the surrounding environment.

The navigation ECU 35 includes a global navigation satellite system (i.e., GNSS) receiver, an inertial sensor, and the like. The navigation ECU 35 sequentially determines the position of the vehicle Ve and the heading direction using positioning signals received by the GNSS receiver from positioning satellites, measurement results of the inertial sensor, vehicle speed information output to the communication line, and the like. The navigation ECU 35 further includes a map database storing map data. The navigation ECU 35 refers to the map data and sets a route from the current position based on the positioning result to a destination specified by a passenger in the vehicle Ve such as a driver. The navigation ECU 35 provides the vehicle control ECU 100, the HMI control device 50, and the like with positioning results, map data, route information indicating a planned route to the destination, and the like. The navigation ECU 35 cooperates with the HMI control device 50 and notifies the driver, as a route navigation to the destination, of the heading direction of the vehicle Ve at an intersection, a branch point, and the like with screen display, voice messages, and the like.

The in-vehicle communication device 36 is an external communication unit mounted on the vehicle Ve. The in-vehicle communication device 36 functions as a Vehicle to Everything (V2X) communication device. The in-vehicle communication device 36 transmits and receives information by wireless communication to and from a roadside device provided along the road and other vehicles around the own vehicle. As an example, the in-vehicle communication device 36 receives, from the roadside device, congestion information and road construction information on the surroundings of the current position and areas in the heading direction of the vehicle Ve. The congestion information and the road construction information are, for example, VICS (registered trademark) information. Furthermore, the in-vehicle communication device 36 receives road surface information stored in the cloud and recognizes slopes and unevenness of the road on the planned route. The in-vehicle communication device 36 sequentially provides the vehicle control ECU 100 with information on traffic congestion, traffic regulations, and road surface information.

The wiper system 37 is a system that wipes away foreign matters adhering to the windshield by operating wipers mounted on the vehicle Ve. The wiper system 37 includes a rain sensor and a control unit. The rain sensor may be an optical sensor or an ultrasonic sensor attached to the windshield. The rain sensor detects the presence of raindrops and the intensity of the rainfall. The control unit determines the operation pattern and operation speed of the wipers in accordance with the intensity of rainfall (the amount of rainfall) based on the detection result of the rain sensor. The control unit may determine the wiper operation pattern and operation speed based on the driver's manual operation. The control unit outputs at least one of the detection result of the rain sensor and information indicating the operation state of the wipers to the vehicle control ECU 100 as rainfall information relating to the amount of rainfall.

The driving control ECU 40 is an electronic control device that mainly includes a microcontroller. The driving control ECU 40 generates vehicle speed information indicating a current driving speed of the vehicle Ve based on a detection signal of wheel speed sensors that are arranged at hub portions of the wheels, and successively outputs the generated vehicle speed information to the communication line. The driving control ECU 40 has at least functions of a brake control ECU, a drive control ECU, and a steering control ECU. The driving control ECU 40 continuously executes a braking force control of each wheel, an output control of a powertrain, and a steering angle control according to any one of an operation command based on a manual operation by the driver and a control command from the vehicle control ECU 100.

The HMI control device 50 is a computer mainly including a control circuit including a processor, a RAM, a memory, and I/O interface, and a bus connecting them.

The HMI control device 50 constitutes an HMI system together with a display device 51, an audio device, an operation device, a steering vibration device, and the like. The display device 51 presents information for the visual sense of the driver by image display. The display device 51 includes a meter display 21, a center information display, a head-up display, and the like. The HMI control device 50 functions as an information presentation control device, and comprehensively controls the information presentation using the display device 51 and the audio device. The vehicle control ECU 100 controls the contents and execution timing of notifications based on a notification request obtained from the HMI control device 50, thereby executing information presentation according to the operation state of the automated driving control.

(Configuration of Vehicle Control ECU) The vehicle control ECU 100 is a computer mainly including a control circuit that includes a processor 11, a RAM 12, a memory 13, and I/O interface, and a bas connecting them. The processor 11 accesses the RAM 12 to execute various processes for performing the vehicle control method according to the present disclosure. The memory 13 stores various programs (e.g., a vehicle control program) to be executed by the processor 11. The execution of the program by the processor 11 constructs, as functional blocks for vehicle control in the vehicle control ECU 100, an environment recognition unit 71, a notification request unit 74, and a behavior control unit 75.

The environment recognition unit 71 recognizes the driving environment around the vehicle with the positioning results, map data, route information, and detection information. The environment recognition unit 71 recognizes road information related to the road on which the vehicle Ve plans to travel. The environment recognition unit 71 recognizes the size, type, a relative position, and a relative speed of a moving object around the own vehicle, such as another vehicle traveling near the own vehicle. The environment recognition unit 71 recognizes the contents of road signs along the road (e.g., speed limits) with traffic sign recognition (TSR) function.

The environment recognition unit 71 includes a rainfall estimating unit 72 and a water level estimating unit 73 as sub functional blocks for the driving environment recognition. The rainfall estimating unit 72 acquires rainfall information relating to the amount of rainfall from the wiper system 37. The rainfall estimating unit 72 estimates the amount of rainfall around the vehicle Ve based on the rainfall information, and determines whether the amount of rainfall around the vehicle Ve remains steady.

The water level estimating unit 73 acquires the detection information generated by the acoustic sensor 30. The detection information of the acoustic sensor 30 is audio data relating to sound vibrations measured at the vehicle Ve. The water level estimating unit 73 combines the audio data with at least one piece of vehicle information acquired from the communication line of the in-vehicle LAN 39 to estimate the condition of the asphalt road surface on which the vehicle Ve is traveling. The water level estimating unit 73 is provided with a learning model for determining road surface conditions (hereinafter, road surface condition determination model) in advance. The road surface condition determination model is generated by learning audio data (road surface sounds), vehicle information, and the like. The water level estimating unit 73 performs inference processing using the audio data and vehicle information as input information for the road surface condition determination model, and estimates the condition of the road surface on which the vehicle Ve is travelling. The water level estimating unit 73 determines, through the inference processing, whether the road surface on which the vehicle Ve is traveling is wet. Furthermore, when the vehicle Ve is traveling on a wet road surface, the water level estimating unit 73 estimates the amount of water accumulated on the road surface on which the vehicle Ve is traveling, in other words, the road surface water level.

The water level estimating unit 73 acquires audio data from one of the left front sensor and the right front sensor that is mounted on the vehicle Ve. Specifically, the water level estimating unit 73 acquires audio data measured at the left portion of the vehicle Ve (hereinafter, referred to as left front wheel audio data) or audio data measured at the right portion of the vehicle Ve (hereinafter, referred to as right front wheel audio data). The water level estimating unit 73 estimates the water level on the road surface on which the vehicle is traveling based on the left front wheel audio data or the right front wheel audio data. Here, when both the left front sensor and the right front sensor are installed in the vehicle Ve, the water level estimating unit 73 separately estimates the left road water level based on the left front wheel audio data and the right road water level based on the right front wheel audio data as estimated water levels on the road surface on which the vehicle Ve is travelling. In this case, the road surface condition determination model to which the left front wheel audio data is input and the road surface condition determination model to which the right front wheel audio data is input may be the same learning model or different learning models.

The water level estimating unit 73 estimates the condition of the road surface on which the vehicle Ve plans to travel, in addition to the condition of the road surface on which the vehicle Ve is traveling. The detection information (image data) from the front camera unit 34 and/or the map data (road surface information) received from the cloud by the in-vehicle communication device 36 are available for the water level estimating unit 73 as information to estimate the road surface condition on the planned route. Specifically, the water level estimating unit 73 estimates the water level on the road surface ahead by recognizing the state of water splashed by the preceding vehicle and the part of the rear tire of the preceding vehicle submerged in water from the image data captured by the front camera unit 34. Additionally, the water level estimating unit 73 estimates areas on the planned route where water is likely to accumulate (hereinafter referred to as water accumulation areas) based on the road slope and unevenness indicated by the road surface information.

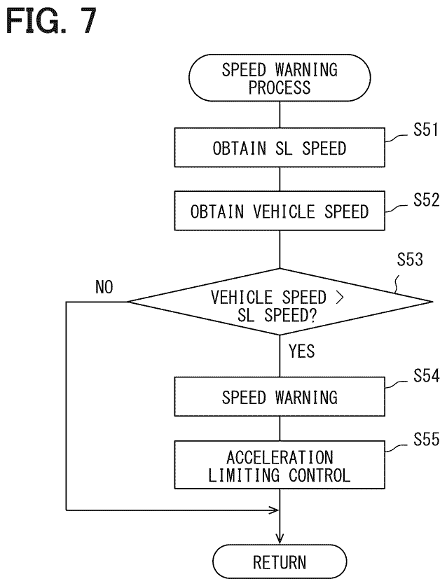

The notification request unit 74 outputs notification execution request to the HMI control device 50 to enable notification execution synchronized with an operation state of the automated driving control. The notification request unit 74 outputs to the HMI control device 50 an execution request for a notification indicating the start of automated driving control and an execution request for a notification requesting the driver to switch driving. Additionally, the notification request unit 74 outputs to the HMI control device 50 an execution request for a notification relating the control based on the water level determination on the road surface. Furthermore, when the driving speed of the vehicle Ve exceeds the speed limit of the road on which the vehicle is traveling or the maximum speed set by the upper limit setting unit 76, which will be described later, the notification request unit 74 outputs to the HMI control device 50 an execution request for vehicle speed warning (see FIG. 7). The vehicle speed warning is an excessive speed alert, which is a notification to passengers such as the driver indicating that the vehicle is speeding.

When automated driving control is executed and the vehicle control ECU 100 has control over driving operations, the behavior control unit 75 determines the behavior of the vehicle Ve based on route information, road information, and driving environment recognition results obtained from the environment recognition unit 71. The behavior control unit 75 generates a planned driving line on which the vehicle Ve is to travel as a driving plan that defines the behavior of the vehicle Ve. The behavior control unit 75 cooperates with the driving control ECU 40 and executes acceleration/deceleration control, steering control, and the like of the vehicle Ve in accordance with the generated driving line. Specifically, the behavior control unit 75 generates control commands based on the planned driving line, and sequentially outputs the generated control commands to the driving control ECU 40.

(Setting Maximum Speed based on Estimated Water Level) When the vehicle control ECU 100 detects a water level at which hydroplaning may occur, the vehicle control ECU 100 limits the driving speed of the vehicle Ve. Furthermore, when the vehicle control ECU 100 detects a water level at which keeping the vehicle speed at ACC control, which will be described later, may be difficult, the vehicle control ECU 100 limits the driving speed of the vehicle Ve. The vehicle control ECU 100 further includes an upper limit setting unit 76 as a functional block for setting a vehicle speed limit.

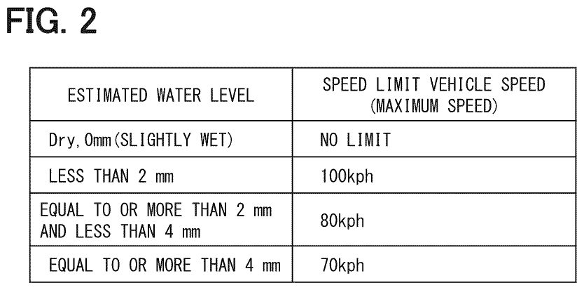

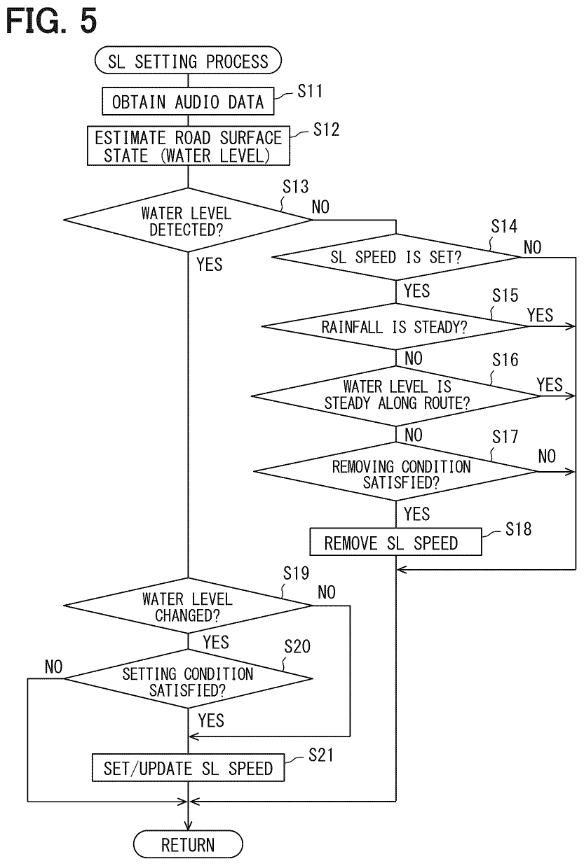

The upper limit setting unit 76 executes a SL (Speed Limit) setting process (see FIG. 5), which will be described later, and sets a maximum speed (SL vehicle speed, see FIG. 2) that is the upper limit of the driving speed of the vehicle Ve based on the estimated water level estimated by the water level estimating unit 73. The upper limit setting unit 76 decreases (lowers) the maximum speed as the estimated water level increases (deepens). The upper limit setting unit 76 gradually decreases the maximum speed as the estimated water level increases, based on a prepared upper limit setting table (see FIG. 2). The upper limit setting unit 76 may successively decrease the maximum speed as the estimated water level increases, based on a prepared upper limit setting function.

Specifically, the upper limit setting unit 76 does not set the maximum speed when the road surface is dry, or when the road surface is slightly wet and the estimated water level is 0 mm (moist state) (see FIG. 2). Furthermore, when the estimated water level is less than 2 mm, the upper limit setting unit 76 sets the maximum speed to 100 kph (km/h). Furthermore, when the estimated water level is equal to or greater than 2 mm and less than 4 mm, the upper limit setting unit 76 sets the maximum speed to 80 kph. When the estimated water level is 4 mm or more, the upper limit setting unit 76 sets the maximum speed to 70 kph. The estimated water level that is the boundary at which the upper limit speed changes and the maximum speed associated with each estimated water level may be changed as appropriate.

When the estimated water level changes from zero (dry or moist), the upper limit setting unit 76 suspends setting the maximum speed based on the changed estimated water level until a predetermined maximum speed setting condition is met. The setting condition may be that the vehicle Ve has traveled for a certain distance (e.g., 5 m) or for a certain time (e.g., one second) after the estimated water level changes. The upper limit setting unit 76 may use only one of the requirements of a certain distance and a certain time as the setting condition, or may use both of them as the setting condition. The upper limit setting unit 76 performs the suspending control for setting the maximum speed when a sudden change in water level is detected, thereby avoiding unnecessarily updating the maximum speed in situations such as where the vehicle Ve passes a puddle. On the other hand, when the water level on the wet road surface gradually increases, the upper limit setting unit 76 immediately sets the maximum speed according to the water level.

When the estimated water level changes beyond a predetermined amount, the upper limit setting unit 76 also suspends setting the maximum speed based on the changed estimated water level. The predetermined amount is set to, for example, about 3 to 4 mm to prevent the maximum speed from switching between multiple stages. As an example, when the estimated water level suddenly changes from approximately 1-2 mm to 5 mm or more, the upper limit setting unit 76 temporarily suspends updating the maximum speed from 100 kph to 70 kph and maintains the current maximum speed of 100 kph. The upper limit setting unit 76 updates the maximum speed to 70 kph when the estimated water level of 5 mm or more is maintained for a certain distance or time, and the set condition is met. On the other hand, when the estimated water level drops to about 1 mm before the certain distance or time is exceeded and the set condition is not met, the upper limit setting unit 76 maintains the set maximum speed of 100 kph.

The upper limit setting unit 76 maintains the set maximum speed until a preset condition for removing the maximum speed is met, even when the estimated water level decreases after the maximum speed is set. The removing condition may be that the vehicle Ve has traveled for a certain distance or a certain time after the maximum speed has been set. The certain distance used in the removing condition may be the same as the certain distance used in the setting condition, or may be a distance (for example, 10 m) longer than the certain distance used in the setting condition. Similarly, the certain time used in the removing condition may be the same as the certain time used in the setting condition, or may be longer than the certain time used in the setting condition (for example, a few seconds). The upper limit setting unit 76 may use only one of the requirements of a certain distance and a certain time as the removing condition, or may use both of them as the removing conditions.

After setting the maximum speed, the upper limit setting unit 76 maintains the set maximum speed when the amount of rainfall estimated by the rainfall estimating unit 72 remains steady, even when the estimated water level on the road surface on which the vehicle is traveling decreases. Additionally, the upper limit setting unit 76 maintains the set maximum speed when the estimated water level on the road surface on the planned route along which the vehicle plans to travel remains steady, even when the estimated water level on the road surface on which the vehicle Ve is travelling after the maximum speed is set. As a result, in a driving environment where it is determined that the amount of rainfall is not changing, the maximum speed according to the estimated maximum water level is maintained and avoids frequent relaxation of the maximum speed when the estimated water level changes slightly.

When two acoustic sensors 30 are mounted on the vehicle Ve and both the left road water level and the right road water level are estimated by the water level estimating unit 73, the upper limit setting unit 76 sets the maximum speed based on these estimated water levels. Specifically, when the left road water level and the right road water level are the same, the upper limit setting unit 76 sets the maximum speed corresponding to these water levels. On the other hand, when the left road water level and the right road water level are different, the upper limit setting unit 76 suspends setting the maximum speed based on the higher one of the left road water level and the right road water level until the above setting condition is met. When the different estimated water levels on the left and right are maintained for a certain distance or time and the set condition is met, the upper limit setting unit 76 updates the maximum speed corresponding to the higher water level. On the other hand, when the setting condition does not meet, that is, when the estimated water levels on the left and right become the same before a certain distance or time has passed, the upper limit setting unit 76 maintains the current maximum speed.

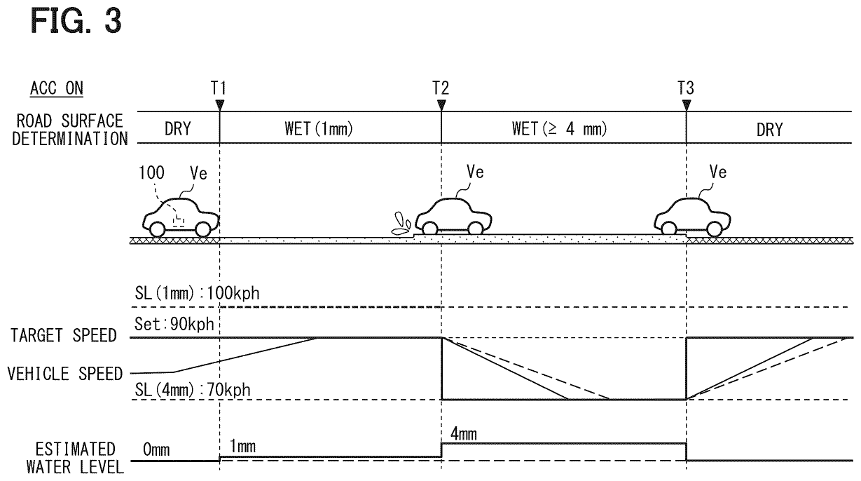

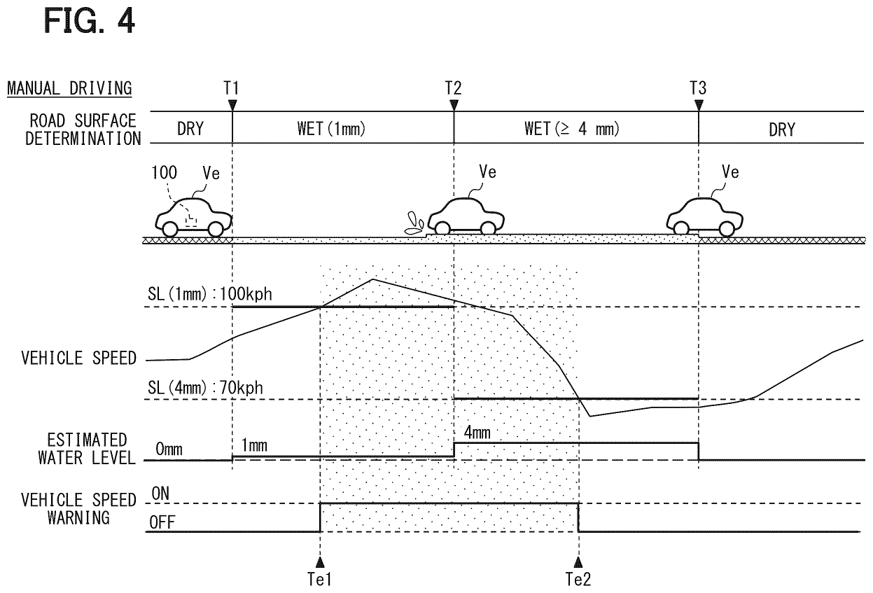

(Speed Limit based on Maximum Speed) Next, the details of the control that limits the driving speed of the vehicle Ve (hereinafter, the vehicle speed) according to the maximum speed set by the upper limit setting unit 76 will be explained based on FIGS. 3 and 4 and with reference to FIG. 1.

(Speed Limit under Control of Vehicle Control ECU) In the automated driving scene shown in FIG. 3, the vehicle Ve is traveling under automated driving control by the vehicle control ECU 100. The behavior control unit 75 controls the vehicle speed by operating an adaptive cruise control (hereinafter, referred to as ACC). When there is a preceding vehicle, the ACC causes the vehicle Ve to follow the preceding vehicle while maintaining a constant distance from the preceding vehicle. When there is no preceding vehicle, the ACC controls the driving speed of the vehicle Ve so that the vehicle Ve travels at an arbitrary vehicle speed set by the driver. In the automated driving scene shown in FIG. 3, the vehicle speed is set to 90 kph in the ACC, for example. The behavior control unit 75 sets the set vehicle speed as a target vehicle speed and accelerates the vehicle Ve until the vehicle speed reaches the target vehicle speed.

At time T1 in the automated driving scene, the vehicle Ve enters a wet road surface. At time T1, the water level estimating unit 73 detects the change in the road surface condition from a dry road surface to a wet road surface, and recognizes the estimated water level (1 mm) on the road surface. The upper limit setting unit 76 sets the maximum speed (100 kph) based on the estimated water level recognized by the water level estimating unit 73. The maximum speed is higher than the set speed of the ACC. Thus, even after time T1, the behavior control unit 75 sets the set speed in the ACC as the target speed, and causes the vehicle Ve to travel at a constant speed of 90 kph, which is the target speed.

At time T2 in the automated driving scene, the amount of water accumulating on the road surface increases. At time T2, the water level estimating unit 73 detects a change in the water level on the road surface and changes the estimated water level from 1 mm to 4 mm. The upper limit setting unit 76 reduces the maximum speed from 100 kph to 70 kph based on the change in the estimated water level. The maximum speed is lower than the set speed in the ACC. Thus, at time T2, the behavior control unit 75 switches the target speed in the ACC from the set speed of 90 kph to the maximum speed of 70 kph. The behavior control unit 75 decelerates the vehicle Ve from time T2 so that the vehicle speed reaches the changed vehicle speed (i.e., the maximum speed of 70 kph). The behavior control unit 75 reduces the deceleration rate from the set speed to the maximum speed when another vehicle is present around the vehicle (see a dashed line of FIG. 3) compared to when no other vehicle is present around the vehicle (see a solid line in FIG. 3). The other vehicle whose presence or absence is determined during the deceleration period is mainly a following vehicle traveling behind the vehicle Ve in the same lane.

During the deceleration period from time T2, the vehicle speed exceeds the maximum speed. When the vehicle speed exceeds the maximum speed, the notification request unit 74 cooperates with the HMI control device 50 to issue a vehicle speed warning. When the automated driving control is in operation, a vehicle speed warning is issued using the display device 51. The display device 51 notifies the passenger that the vehicle speed exceeds the target speed by highlighting the target speed through means such as enlarging the size, flashing, or changing the color. The vehicle speed warning while the automated driving control is operating may be omitted.

At time T3 in the automated driving scene, the vehicle Ve leaves the wet road surface. At time T3, the water level estimating unit 73 detects a change in the road surface condition from the wet road surface to a dry road surface. The upper limit setting unit 76 removes the set maximum speed based on a change in the road surface condition detected by the water level estimating unit 73. As a result, the behavior control unit 75 switches the target speed for the ACC from the maximum speed of 70 kph to the set speed of 90 kph. The behavior control unit 75 accelerates the vehicle Ve after time T3 so that the vehicle speed reaches the changed target speed (i.e., the set speed). The behavior control unit 75 reduces the acceleration rate to the set speed when another vehicle is present around the vehicle Ve (see dashed line in FIG. 3) compared to when another vehicle is not present around the vehicle Ve (see solid line in FIG. 3). The other vehicle whose presence or absence is determined during the acceleration period is mainly a preceding vehicle that is traveling in the same lane as the vehicle Ve. The control for changing the acceleration rate during the acceleration period, depending on the presence or absence of a preceding vehicle, is not always necessary.

(Speed Limit under Driver's Control) In the manual driving scene shown in FIG. 4, the vehicle Ve is driven by the driver. The vehicle control ECU 100 can continue to operate in the background even during a manual driving period when the automated driving control is not being executed, and can assist the driver's manual operation through control intervention by the behavior control unit 75. The behavior control unit 75 controls the vehicle speed to fall below the maximum speed. Specifically, when the vehicle speed exceeds the maximum speed or is about to exceed the maximum speed, the behavior control unit 75 controls the vehicle speed to fall below the maximum speed by limiting acceleration. In addition, when the vehicle speed exceeds the maximum speed, the behavior control unit 75 may execute deceleration control until the vehicle speed falls below the maximum speed.

At time T1 in the manual driving scene, the vehicle Ve enters a wet road surface. At time T1, the water level estimating unit 73 detects the change in the road surface condition from a dry road surface to a wet road surface, and recognizes the estimated water level (1 mm) on the road surface. The upper limit setting unit 76 sets the maximum speed (100 kph) based on the estimated water level recognized by the water level estimating unit 73.

At time Te1 when the vehicle speed exceeds the maximum speed due to an acceleration operation by the driver, the notification request unit 74 cooperates with the HMI control device 50 to issue a vehicle speed warning. The vehicle speed warning during manual driving periods is emphasized more than the vehicle speed warning when automated driving control is active. Specifically, the notification request unit 74 can execute vehicle speed warning using voice messages or warning sounds with an audio device and a change of the color of ambient light in addition to vehicle speed warning using the display device 51. The behavior control unit 75 starts acceleration limiting control of the vehicle Ve after issuing a vehicle speed warning or simultaneously with the issuing of the vehicle speed warning. The behavior control unit 75 may start deceleration control of the vehicle Ve. The behavior control unit 75 continues the acceleration limiting control or the deceleration control until the vehicle speed falls below the maximum speed.

At time T2 in the manual driving scene, the amount of water accumulating on the road surface increases. At time T2, the water level estimating unit 73 detects a change in the water level on the road surface and changes the estimated water level from 1 mm to 4 mm. The upper limit setting unit 76 lowers the maximum speed from 100 kph to 70 kph based on the change in the estimated water level. The maximum speed is less than the vehicle speed. Thus, the behavior control unit 75 continues the acceleration limiting control or the deceleration control. When the deviation between the maximum speed and the vehicle speed increases due to the lowering of the maximum speed and the deviation amount by which the vehicle speed from the target speed exceeds a predetermined value, the behavior control unit 75 increases the upper limit of the deceleration rate in the deceleration control.

Due to the continuous intervention in the deceleration control by the behavior control unit 75, the vehicle speed becomes equal to or lower than the maximum speed at time Te2. The notification request unit 74 ends at time Te2 the vehicle speed warning that started at time Te1. In addition, the behavior control unit 75 ends the acceleration limiting control or the deceleration control after time Te2. In this manner, the control right for controlling the vehicle speed is handed over to the driver. After the deceleration control ends, the behavior control unit 75 may continue the control to limit acceleration due to the accelerator operation by the driver. Furthermore, when the vehicle speed exceeds the maximum speed again, the behavior control unit 75 resumes the acceleration limiting control or the deceleration control.

At time T3 in the manual driving scene, the vehicle Ve leaves the wet road surface. At time T3, the water level estimating unit 73 detects a change in the road surface condition from the wet road surface to a dry road surface. The upper limit setting unit 76 removes the set maximum speed of 70 kph based on the change in the road surface condition detected by the water level estimating unit 73. This allows the driver to increase the driving speed of the vehicle Ve to a speed exceeding the maximum speed set in the wet condition without control intervention by the behavior control unit 75.

(Details of Processes related to Setting Maximum Speed) Next, the details of the SL setting process that sets the maximum speed, the vehicle speed control process that limits the driving speed of the vehicle Ve, and the vehicle speed warning process that alerts the driver when the maximum speed is exceeded will be explained below based on FIGS. 5 to 7 and with reference to FIGS. 1 to 4.

(SL Setting Process) The SL setting process shown in FIG. 5 is started by the water level estimating unit 73 and the upper limit setting unit 76 when the shift position of the vehicle Ve is set to the drive range and the vehicle Ve is ready for traveling. The SL setting process is repeatedly performed until the shift position of the vehicle Ve is switched to the parking range.

In S11 of the SL setting process, the water level estimating unit 73 acquires audio data related to sound vibrations generated near the tires of the vehicle Ve. In S12, the water level estimating unit 73 estimates the state of the road surface on which the vehicle Ve is traveling based on the acquired audio data. When the vehicle Ve is traveling on a wet road surface, the water level estimating unit 73 estimates the road surface water level in S12.

In S13, the upper limit setting unit 76 determines whether the water level estimating unit 73 has detected a water level. When the vehicle Ve is traveling on a dry road surface or a slightly wet road surface (moist road surface), the water level estimating unit 73 does not detect the water level, as an example. As another example, the water level estimating unit 73 may not detect the water level only when the vehicle Ve is traveling on a dry surface, and may detect a very small amount of water level when the vehicle Ve is traveling on a wet road surface that is only slightly wet. When the water level estimating unit 73 has not detected the water level, the upper limit setting unit 76 determines that a water level has not been detected (S13: NO), and in S14 determines whether a maximum speed has been set. When the maximum speed has not been set (S14: NO), the upper limit setting unit 76 maintains the OFF state for the maximum speed, and ends the current SL setting process.

When the upper limit speed has been set (S14: YES), the upper limit setting unit 76 determines in S15 whether the amount of rainfall estimated by the rainfall estimating unit 72 remains steady. If the amount of rainfall around the vehicle remains steady (S15: YES), the upper limit setting unit 76 determines to keep the set maximum speed and ends the current SL setting process. On the other hand, when the amount of rainfall around the vehicle is decreasing (S15: NO), the upper limit setting unit 76 determines in S16 whether the estimated water level on the road surface on which the vehicle Ve plans to travel remains steady. When the estimated water level on the planned route remains steady (S16: YES), the upper limit setting unit 76 determines to maintain the current maximum speed, and ends the current SL setting process.

On the other hand, when the estimated water level on the road surface on which the vehicle Ve plans to travel is decreasing (S16: NO), the upper limit setting unit 76 determines in S17 whether a removing condition for the set maximum speed is met. If the removing condition is not met (S17: NO), the upper limit setting unit 76 determines to maintain the current maximum speed, and ends the current SL setting process. As described above, the set maximum speed is maintained for a certain distance or a certain time after the maximum speed is set, even when the estimated water level decreases. On the other hand, when the removing condition is met (S17: YES), the upper limit setting unit 76 removes the current maximum speed (i.e., the SL vehicle speed) in S18, and ends the current SL setting process.

When it is determined that the water level has been detected by the water level estimating unit 73 (S13: YES), the upper limit setting unit 76 determines in S19 whether a specific water level change has occurred. As described above, when the estimated water level changes from zero, or when the estimated water level changes beyond a predetermined amount, the upper limit setting unit 76 determines that a specific water level change has occurred. If the detected water level change does not correspond to the specific water level change (S19: NO), the upper limit setting unit 76 sets the maximum speed based on the latest estimated water level in S21. When the maximum speed has already been set, the upper limit setting unit 76 updates the maximum speed based on the latest estimated water level in S21.

On the other hand, when the detected water level change corresponds to the specific water level change (S19: YES), the upper limit setting unit 76 determines in S20 whether the setting condition for the maximum speed is met. If the setting condition is not met (S20: NO), the upper limit setting unit 76 maintains the current maximum speed, and ends the current SL setting process. On the other hand, when the setting condition is met (S20: YES), the upper limit setting unit 76 sets or updates the maximum speed based on the latest estimated water level in S21.

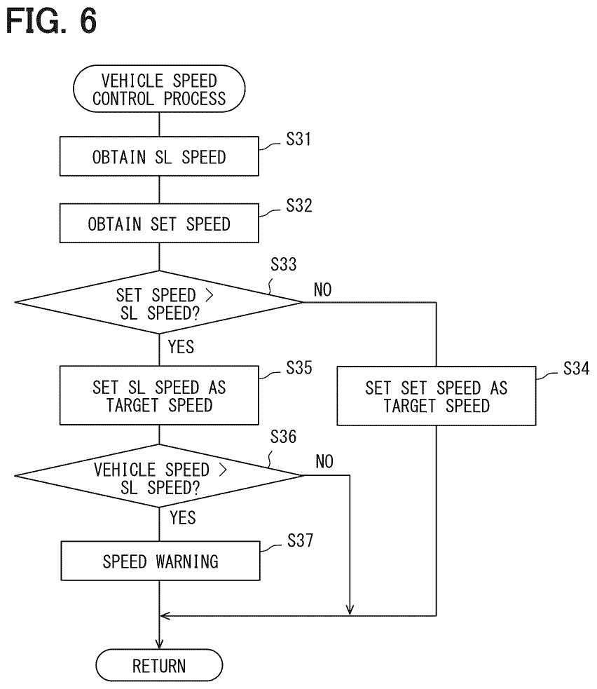

(Vehicle Speed Control Process) The vehicle speed control process shown in FIG. 6 is started by the behavior control unit 75 when the automated driving control by the vehicle control ECU 100 is turned on and the ACC is activated. The vehicle speed control process is repeatedly performed until the automated driving control is turned off.

In S31 of the vehicle speed control process, the behavior control unit 75 obtains the maximum speed (i.e., SL vehicle speed) set by the upper limit setting unit 76. Furthermore, the behavior control unit 75 acquires the set speed set in the ACC in S32. In S33, the behavior control unit 75 compares the maximum speed with the set speed, and determines whether the maximum speed is less than the set speed. When the maximum speed is higher than the set speed (S33: NO), the behavior control unit 75 sets the set speed as the target speed for the ACC in S34. As a result, the behavior control unit 75 controls the vehicle speed so that the vehicle Ve travels at the set speed.

On the other hand, when the maximum speed is lower than the set speed (S33: YES), the behavior control unit 75 sets the maximum speed as the target speed for the ACC in S35. As a result, the behavior control unit 75 controls the vehicle speed so that the vehicle Ve travels at the maximum speed. Furthermore, the notification request unit 74 determines in S36 whether the vehicle speed is greater than the maximum speed. When the vehicle speed is greater than the maximum speed (S36: YES), the notification request unit 74 issues a vehicle speed warning to the driver in order to notify the driver that the vehicle is speeding in S37. On the other hand, when the vehicle speed is less than the maximum speed (S36: NO), the vehicle speed warning in S37 is skipped.

(Vehicle Speed Warning Process) The vehicle speed warning process shown in FIG. 7 is started by the notification request unit 74 and the behavior control unit 75 when the vehicle Ve is ready for traveling. The vehicle speed warning process is repeatedly performed until the shift position of the vehicle Ve is switched to the parking range. Furthermore, when the automated driving control is in the ON state, the vehicle speed warning process may be temporarily suspended, and when the automated driving control is turned OFF, the vehicle speed warning process may be resumed.

In S51 of the vehicle speed warning process, the notification request unit 74 obtains the maximum speed (i.e., the SL vehicle speed) set by the upper limit setting unit 76. Furthermore, the notification request unit 74 acquires the current vehicle speed of the vehicle Ve in S52. In S53, the notification request unit 74 compares the vehicle speed with the maximum speed and determines whether the vehicle speed is greater than the maximum speed. When the vehicle speed is less than the maximum speed (S53: NO), the notification request unit 74 ends the current vehicle speed warning process.

On the other hand, when the vehicle speed is greater than the maximum speed (S53: NO), the notification request unit 74 issues a vehicle speed warning to the driver as a notification indicative of excessive speed in S54. Furthermore, the behavior control unit 75 intervenes in the driving operation by the driver in S55. The behavior control unit 75 executes acceleration limiting control or deceleration control to decelerate the vehicle speed to the maximum speed.

(Overview of Embodiment) In the embodiment described so far, the water level on the road surface on which the vehicle Ve is travelling is estimated based on audio data, so that a maximum speed can be set according to the water level on the road surface. Thus, the traveling speed of the vehicle Ve is limited in accordance with the maximum speed, thereby allowing the vehicle Ve to travel without causing hydroplaning.

Additionally, in this embodiment, the set maximum speed is maintained for a certain distance or a certain time after the maximum speed is set, even when the estimated water level decreases. This prevents the maximum speed from being frequently set or removed, thereby keeping the vehicle speed stable.

In this embodiment, the amount of rainfall around the vehicle Ve is estimated. The set maximum speed is maintained after the maximum speed is set when the estimated amount of rainfall remains steady, even when the estimated water level decreases. This prevents the maximum speed from being removed or relaxed based on a slight change in the water level on the road in a driving environment where it keeps raining and the water level on the road is less likely to decrease. The vehicle control ECU 100 can control the vehicle Ve to travel in an environment where it keeps raining not to cause hydroplaning.

Furthermore, in this embodiment, the water level on the road surface on which the vehicle Ve plans to travel is further estimated. The set maximum speed is maintained when the estimated water level on the road surface on which the vehicle plans to travel remains steady, even when the estimated water level on the road surface on which the vehicle Ve is travelling decreases after the maximum speed is set. As described above, by further estimating the water level on the road surface on which the vehicle plans to travel, unnecessary removing or relaxing the maximum speed can be avoided, even when the estimated water level is temporarily decreased by slopes or road surface unevenness. As a result, the vehicle control ECU 100 can control the vehicle Ve to travel while limiting the vehicle speed to prevent hydroplaning.

In addition, in this embodiment, setting of the maximum speed based on the newest estimated water level is suspended for a certain distance or certain time when the estimated water level is changed from zero or changed beyond the predetermined amount. Thus, unnecessary deceleration can be avoided in a travelling scene where the vehicle Ve passes through a puddle.

In this embodiment, the left road water level based on audio data measured at the left part of the vehicle Ve and the right road water level based on audio data measured at the right part of the vehicle Ve are estimated as the estimated water level. When the left road water level and the right road water level are different, setting of the maximum speed based on the higher one of the left road water level and the right road water level is suspended for a certain distance or time. This avoids unnecessary deceleration in a driving scene where only one tire passes through a puddle.

Furthermore, in this embodiment, the driving speed of the vehicle Ve is controlled such that the vehicle Ve travels at a set speed set by a passenger like a driver during operation of the ACC. The vehicle speed is controlled at the maximum speed when the maximum speed is less than the set speed. When water accumulates on the road surface, the set speed may not be kept with the upper limit torque of the ACC due to the resistance caused by the water on the road surface. However, the target speed can be switched to a value maintainable with the upper limit torque of the ACC by the process to lower the target speed from the set speed to the maximum speed. As a result, situations where the vehicle speed control by the ACC is hindered by water pressure, making it difficult to maintain the set speed and causing the control to be canceled, are less likely to occur.

Additionally, in this embodiment, the deceleration rate of the vehicle Ve from the set speed to the maximum speed is reduced when another vehicle is present around the vehicle Ve compared to when another vehicle is not present around the vehicle Ve. That is, the deceleration rate is adjusted without sudden deceleration in a situation where another vehicle is present around the vehicle Ve. Thus, the vehicle Ve can keep the distance with the other vehicle in a driving environment with poor visibility.

In this embodiment, the driving speed of the vehicle Ve during the manual operation by the driver is controlled to fall below the maximum speed. As described above, the vehicle control ECU 100 intervenes in the acceleration limiting control, even during periods when the vehicle Ve travels by manual operation, allowing the vehicle Ve to travel while limiting the vehicle speed not to cause hydroplaning.

Furthermore, in this embodiment, vehicle speed warning is performed to the driver as a notification indicative of excessive speed when the vehicle speed is greater than the maximum speed. The speed warning allows the driver to recognize that the vehicle speed exceeds the maximum speed. This reduces the sense of discomfort felt by the driver in response to deceleration control that reduces the vehicle speed below the maximum speed.

In addition, in the above embodiment, the notification request unit 74 corresponds to the “notification execution unit”, the behavior control unit 75 corresponds to the “driving control unit”, the vehicle control ECU 100 corresponds to the “vehicle controller”, and the set vehicle speed corresponds to the “target setting speed”.

(Other embodiments) Although one embodiment of the present disclosure has been described above, the present disclosure is not construed as being limited to the above-mentioned embodiment, and can be applied to various embodiments and combinations within a scope that does not depart from the gist of the present disclosure.

In the above embodiment, the water level estimating unit 73 estimates whether the road surface is dry, moist, or wet based on the road surface sounds of the vehicle Ve traveling on an asphalt road surface. However, the type of road surface whose condition is estimated is not limited to asphalt. The water level estimating unit 73 may be capable of estimating the conditions of road surfaces concrete, cobblestones, gravel, etc., based on audio data.

Furthermore, the water level estimating unit 73 may function as a snow accumulation estimating unit and estimate the road surface condition and driving condition using audio data (tire sound) when the vehicle Ve runs on a snowy road. Specifically, the snow accumulation estimating unit estimates that the vehicle Ve is traveling on a snowy road by detecting the sound of the tires compressing snow just before the vehicle Ve stops. Based on the snowy road determination by the snow accumulation estimating unit, the behavior control unit 75 turns the steering wheels more in the steering control for automatic parking than in the steering control for automatic parking on a dry road surface. By correcting the steering amount in this manner, the behavior control unit 75 can accurately move the vehicle Ve into the target parking space even when the cold tires slip on the road surface.

Furthermore, when the driving control ECU 40 includes the function of a steering control ECU, the driving control ECU 40 changes the steering gear ratio based on the snowy road determination made by the snow accumulation estimating unit. More specifically, the steering gear ratio is the ratio between the handle angle (steering angle) and the actual tire angle (actual steering angle). The higher the gear ratio, the greater the change in tire angle in response to a change in steering angle. The steering system of the vehicle Ve is provided with a gear ratio variable mechanism that changes the steering gear ratio. The driving control ECU 40 cooperates with the gear ratio variable mechanism to increase the steering gear ratio when the vehicle Ve is travelling on a snowy road. In other words, the driving control ECU 40 performs tire turning using the variable gear ratio mechanism in response to the driver's steering operation.

When the snow accumulation estimating unit determines that the vehicle Ve is traveling on a snowy road, the snow accumulation estimating unit estimates whether a tire is about to leave a rut by detecting the sound of the tire that has left the rut stepping on snow. When a tire is about to leave the rut, the driving control ECU 40 executes driving control to return the tire to the rut. Specifically, the driving control ECU 40 generates a force in the yaw direction in the vehicle Ve through steering control or braking control, and controls the vehicle behavior so that the tires travel along the ruts.

In the first modification of the above embodiment, the upper limit setting unit 76 does not perform at least one of the following processes: suspending the setting of the maximum speed based on whether the setting condition is met, and suspending the removing of the maximum speed based on whether the removing condition is met. In addition, in the second modification of the above embodiment, the upper limit setting unit 76 does not perform at least one of the following processes: suspending the removing of the maximum speed based on the estimated amount of rainfall, and suspending removing of the maximum speed based on the estimated water level on the road surface on which the vehicle Ve plans to travel. Furthermore, in the third modification of the above embodiment, the deceleration rate adjustment depending on the presence or absence of other vehicles is not performed. In addition, in the fourth modification of the above embodiment, the vehicle speed warning is not issued during the period when the vehicle speed exceeds the maximum speed.

The number and positions of the acoustic sensors 30 may be changed as appropriate. In the fifth modification of the above embodiment, the acoustic sensors 30 are installed respectively near all four wheels of the vehicle Ve. In the sixth modification of the above embodiment, the acoustic sensor 30 is installed near only one of the left front tire or the right front tire. Furthermore, the acoustic sensor 30 is not limited to being placed inside the fender, but may be placed inside the side sill, bumper, or the like, as long as the acoustic sensor 30 is capable of collecting road surface sounds near the tire.

In the in-vehicle system according to the seventh modification of the above embodiment, a signal processing ECU is provided in addition to the vehicle control ECU 100. The signal processing ECU is a dedicated ECU for processing the detection signal of the acoustic sensor 30. The signal processing ECU has the function of the water level estimating unit 73. In the seventh modified example, a system including the vehicle control ECU 100 and the signal processing ECU corresponds to a “vehicle controller.” In the eighth modification of the above embodiment, the functions of the HMI control device 50 are integrated into the vehicle control ECU 100. In this eighth modification, the integrated functional block of the HMI control device 50 corresponds to the “notification execution unit.”

In the above embodiment and modifications, the respective functions provided by the vehicle control ECU 100 can be also provided by software and hardware for executing the software, only software, only hardware, and complex combinations of software and hardware. In cases where functions are provided by electronic circuits as hardware, the functions can be also provided by analog circuits or digital circuits which include a large number of logic circuits.

In the foregoing embodiments, the processor may include at least one operational core, such as a central processing unit (CPU) or a graphics processing unit (GPU). The processing unit may further include a field-programmable gate array (FPGA), a neural network processing unit (NPU), an IP core having another dedicated function, and the like. Additionally, the processor is not limited to being a chip configuration in which chips are individually mounted on a printed circuit board. Alternatively, a configuration implemented in an application specific integrated circuit (ASIC), a system on chip (SoC), a chiplet assembly, an FPGA, or the like may correspond to the processor.

The form of a storage medium (a non-transitory tangible computer readable medium) that stores various programs and the like may also be appropriately changed. Furthermore, the storage medium is not limited to the configuration provided on the circuit board, and may be provided in the form of a memory card or the like. The storage medium may be inserted into a slot portion, and electrically connected to the control circuit of the vehicle control ECU 100. The storage medium may be an optical disc, a hard disk drive, or the like used as a source of copying or distributing a program to the vehicle control ECU 100.

The control circuit and the method thereof which have been described in the present disclosure may be also implemented by a special purpose computer which includes a processor programmed to execute one or more functions implemented by a computer program. Alternatively, the control circuit and the control method described in the present disclosure may be implemented by a special purpose hardware logic circuit. Alternatively, the control circuit and the control method described in the present disclosure may be implemented by one or more special purpose computers configured by a combination of a processor executing a computer program and one or more hardware logic circuits. The computer programs may be stored, as instructions to be executed by a computer, in a tangible non-transitory computer-readable medium.

The present disclosure also includes a vehicle control method including a step of estimating a water level on a road surface on which a vehicle is traveling based on audio data related to sound vibrations measured at the vehicle, and a step of setting a maximum speed, which is an upper limit of a driving speed of the vehicle, based on the water level estimated by the water level estimating unit. The vehicle control method is performed at least one processor.

1. A vehicle controller comprising:
a water level estimating unit configured to estimate a water level on a road surface on which a vehicle is traveling based on audio data related to sound vibrations measured at the vehicle; and
an upper limit setting unit configured to set a maximum speed based on the water level estimated by the water level estimating unit, the maximum speed being an upper limit of a driving speed of the vehicle.

2. The vehicle controller according to claim 1, wherein
the upper limit setting unit is configured to maintain the set maximum speed for a certain distance or a certain time even when the water level decreases after the maximum speed is set.

3. The vehicle controller according to claim 1, further comprising a rainfall estimating unit configured to estimate an amount of rainfall around the vehicle, wherein
the upper limit setting unit is configured to maintain the set maximum speed based on the amount of rainfall estimated by the rainfall estimating unit remaining steady even when the water level decreases after the maximum speed is set.

4. The vehicle controller according to claim 1, wherein
the water level estimating unit is further configured to estimate a water level on a road surface on which the vehicle plans to drive, and
the upper limit setting unit is further configured to maintain the set maximum speed based on the water level on the road surface on which the vehicle plans to drive remaining steady even when the water level on the road surface on which the vehicle is traveling decreases after the maximum speed is set.

5. The vehicle controller according to claim 1, wherein
the upper limit setting unit is configured to, when a change in the water level from zero is observed, or when a change in the water level exceeding a predetermined amount is observed, suspend setting the maximum speed based on the water level for a certain distance or a certain time after the change.

6. The vehicle controller according to claim 1, wherein
the water level estimating unit is configured to estimate, as the water level, a left road water level based on the audio data measured at a left portion of the vehicle and a right road water level based on the audio data measured at a right portion of the vehicle, and
the upper limit setting unit is configured to suspend setting the maximum speed based on higher one of the left road water level and the right road water level for a certain distance or a certain time when the left road water level is different from the right road water level.

7. The vehicle controller according to claim 1, further comprising a driving control unit configured to control the driving speed of the vehicle such that the vehicle travels at a target setting speed that is set by a passenger in the vehicle, wherein
the driving control unit is configured to control the driving speed such that the vehicle travels at the maximum speed based on the maximum speed being less than the target setting speed.

8. The vehicle controller according to claim 7, wherein
the driving control unit is configured to reduce a deceleration rate from the target setting speed to the maximum speed when another vehicle is present around the vehicle compared to when no other vehicle is present around the vehicle.

9. The vehicle controller according to claim 1, further comprising
a driving control unit configured to control the driving speed during manual driving to be less than the maximum speed.

10. The vehicle controller according to claim 1, further comprising a notification execution unit configured to issue a notification indicative of excessive speed to a passenger in the vehicle based on the driving speed being greater than the maximum speed.

11. A computer readable storage medium comprising a vehicle control program configured, when executed by a processor, to cause the processor to:
estimate a water level on a road surface on which a vehicle is traveling based on audio data related to sound vibrations measured at the vehicle; and
set a maximum speed that is an upper limit of a driving speed of the vehicle based on the estimated water level.
